(19) United States
(12) Patent Application Publication
(10) Pub. No.: US 2026/0369301 A1
(43) Pub. Date: Nov. 19, 2026

(54) DISK CLAMP AND DISK DEVICE

(71) Applicants: Kabushiki Kaisha Toshiba, Kawasaki-shi (JP); Toshiba Electronic Devices & Storage Corporation, Kawasaki-shi (JP)

(72) Inventor: Manabu Uehara, Kawasaki Kanagawa (JP)

(21) Appl. No.: 19/357,825

(22) Filed: Oct. 14, 2025

(30) Foreign Application Priority Data
May 19, 2025 (JP) 2025-083099

(51) Int. Cl. G11B 17/038

(52) U.S. Cl. CPC G11B 17/038

(57) ABSTRACT

According to one embodiment, a disk clamp includes a disk-shaped main body having a flat first surface, a second surface on an opposite to the first surface, a center axis perpendicular to the first surface, and an inner hole formed coaxially with the center axis. The main body includes a ring-shaped pressing portion having a first thickness along the center axis, a ring-shaped fixation portion having a second thickness thicker than the first thickness and an inner hole, and provided on an inner circumferential side of the pressing portion, an mount groove formed in the inner circumferential surface of the inner hole, in which the balance adjustment member can be accommodated, and a plurality of through holes each formed in the fixation portion, through which fixation screws can be inserted.

### CROSS-REFERENCE TO RELATED APPLICATIONS

This application is based upon and claims the benefit of priority from Japanese Patent Application No. 2025-083099, filed May 19, 2025, the entire contents of which are incorporated herein by reference.

### FIELD

Embodiments described herein relate generally to a disk clamp and a disk device.

### BACKGROUND

As a disk drive, for example, a hard disk drive (HDD) comprises a plurality of magnetic disks disposed to be rotatable in a housing, a plurality of magnetic heads that read and write information to and from the magnetic disks, and a head actuator that supports the magnetic heads to be movable with relative to the magnetic disks, respectively. On the bottom wall of the housing, a spindle motor is provided. The magnetic disks are mounted on the hub of the spindle motor and further fixed to the hub by a disk-shaped clamp.

Usually, a plurality of magnetic disks are stacked alternately with spacer rings on the hub of the spindle motor and fixed in place with the clamp. But, due to the gap between the inner diameters of the magnetic disks and the outer diameter of the hub, the magnetic disks may be stacked eccentrically in some cases. In such cases, a displacement (imbalance) in the center of gravity of the rotating body occurs.

The imbalance of the rotating body acts as a vibration source for the device itself and surrounding structures, causing adverse effects such as degradation in the performance of the magnetic disk device. To avoid this, it is desirable to minimize the imbalance as much as possible. Here, a method is known for correcting imbalance, in which an arc-shaped wire is installed in a groove of the disk clamp and the imbalance is adjusted to ensure that it remains within a certain limit. The amount of imbalance correction can be adjusted by changing the length of the wire. Further, by enlarging the thickness of the wire to increase the weight, the capability of correcting the imbalance of the wire can be enhanced.

On the other hand, in order to achieve a large-scale storage capacity of magnetic disk devices, the number of magnetic disks installed is increasing, while the spacing between disks is decreasing. As the number of disks increases, the thickness of the disks themselves tends to decrease. To increase the number of disks, it is necessary to increase the disk installation space. To expand the disk installation space itself, it is desirable to thin the clamp.

However, when a groove is provided in the clamp for mounting wire for the adjustment of imbalance, it is necessary to maintain the thickness of the clamp itself at a certain level or above, which makes it difficult to thin the clamp.

### BRIEF DESCRIPTION OF THE DRAWINGS

FIG. 1 is an exploded perspective view showing a hard disk drive (HDD) according to the first embodiment when a top cover thereof is removed.

FIG. 2 is a cross-sectional view of the HDD taken along the line A-A in FIG. 1.

FIG. 3 is a perspective view of a disk clamp and an imbalance adjustment member (wire).

FIG. 4 is a perspective view of the disk clamp when a wire is installed.

FIG. 5 is a cross-sectional view of the portion of the disk clamp shown in FIG. 2, showing the part of FIG. 2 enlarged.

FIG. 6A is a cross-sectional view showing a disk clamp according to a comparative example.

FIG. 6B is a cross-sectional view showing the disk clamp according to this embodiment.

FIG. 7 is a diagram showing comparisons between various HDDs with different numbers of disks, disk materials, and diameters in terms of the ratios of imbalance occurring.

FIG. 8 is a perspective view of a disk clamp and imbalance adjustment member (wire) of an HDD according to the second embodiment.

FIG. 9 is a perspective view of the disk clamp when a wire is installed in the second embodiment.

FIG. 10 is a cross-sectional view of the disk clamp taken along the line B-B in FIG. 9.

### DETAILED DESCRIPTION

Various embodiments will be described hereinafter with reference to the accompanying drawings. In general, according to one embodiment, a disk clamp comprises a disk-shaped main body having a flat first surface, a second surface on an opposite to the first surface, a center axis perpendicular to the first surface, and an inner hole formed coaxially with the center axis. The main body includes a ring-shaped pressing portion having a first thickness along the center axis, a ring-shaped fixation portion having a second thickness thicker than the first thickness and the inner hole, and located on an inner circumferential side of the pressing portion, an mount groove formed in the inner circumferential surface of the inner hole, in which the balance adjustment member can be accommodated, and a plurality of through holes each formed in the fixation portion, through which fixation screws can be inserted.

Note that the disclosure is merely an example, and proper changes in keeping with the spirit of the invention, which are easily conceivable by a person of ordinary skill in the art, come within the scope of the invention as a matter of course. In addition, in some cases, in order to make the description clearer, the drawings show schematic illustration rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by the reference numbers, detailed description thereof being omitted unless necessary.

### First Embodiment

As a disk device, a hard disk drive (HDD) according to the first embodiment will be described in detail.

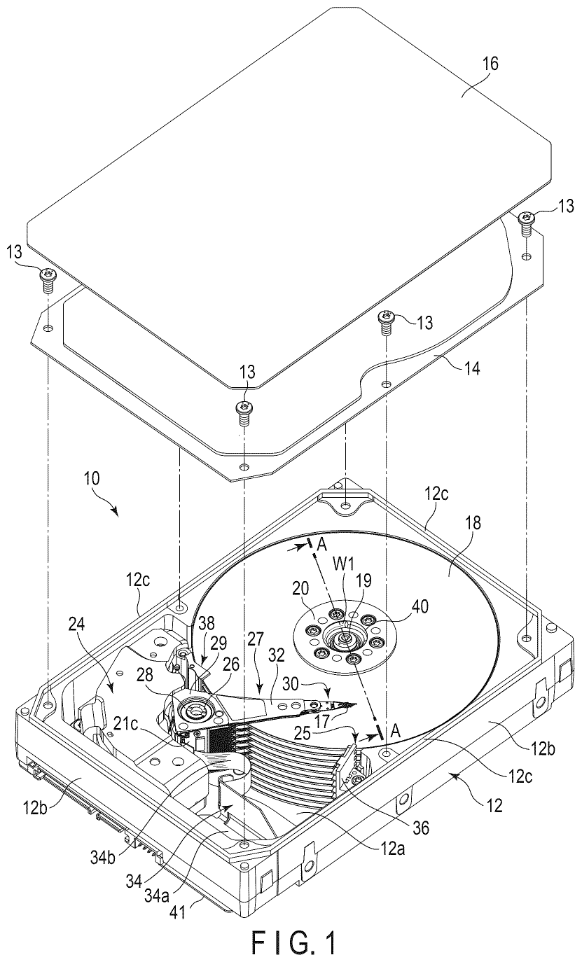

FIG. 1 is an exploded perspective view of the HDD of the first embodiment, when a cover thereof is removed.

As shown in FIG. 1, the HDD comprises a housing 10 having a substantially rectangular shape. The housing 10 includes a rectangular box-shaped base 12 an upper surface of which is opened, an inner cover 14 that is screwed to the base 12 by multiple screws 13 and closes the upper opening of the base 12, and an outer cover (top cover) 16 that is overlaid on the inner cover 14, a peripheral portion of which is welded to the base 12. The base 12 includes a rectangular bottom wall 12a facing the inner cover 14 with a gap therebetween, and side walls 12b formed to stand upright along the periphery of the bottom wall 12a, which are formed to be integrated as one body, for example, from an aluminum alloy.

The inner cover 14 is formed, for example, from stainless steel into a rectangular plate shape. The inner cover 14 is fixed to the upper surface of the side walls 12b by screws 13 at its peripheral edges and secured to an inner side of the fixation rib 12c. The outer cover 16 is formed, for example, as a rectangular plate made of aluminum. The outer cover 16 is formed to have planar dimensions slightly larger than those of the inner cover 14. The outer cover 16 is welded to the fixation rib 12c of the base 12 over the entire circumference of the peripheral portion thereof, and thus hermetically fixed to the base 12. After fixing the outer cover 16, a gas having a density lower than that of air, such as helium (He), is sealed inside the housing 10.

Inside the housing 10, a plurality of, for example, twelve magnetic disks 18 as disk-shaped recording media, and a spindle motor (drive motor) 19 that supports and rotates the magnetic disks 18 are provided. The spindle motor 19 is mounted on the bottom wall 12a. Each of the magnetic disks 18 is formed into a circular plate, for example, having a diameter of 97 mm (3.5 inches) and a thickness of 0.43 mm. The magnetic disks 18 each include a substrate made of a non-magnetic material such as glass or aluminum, and a magnetic recording layer formed on each of the upper and lower surfaces of the substrate. The magnetic disks 18 are fitted to the spindle hub of the spindle motor 19 so as to be coaxial with each other, which will be described later, and further clamped by a disk clamp (hereinafter referred to as a clamp) 20. With this configuration, the magnetic disks 18 are supported in such a state that they are parallel to the bottom wall 12a of the base 12. The magnetic disks 18 are rotated at a predetermined rotational speed by the spindle motor 19. Note that the number of magnetic disks 18 is not limited to twelve, but may as well be eleven or less, or thirteen or more.

Inside the housing 10, a plurality of magnetic heads 17 that record and reproduce information with respect to the magnetic disks 18, and an actuator assembly 27 that supports these magnetic heads 17 so as to be freely movable with relative to the magnetic disks 18, respectively. Further, the housing 10 contains a voice coil motor (VCM) 24 that pivots and positions the actuator assembly 27, a ramp load mechanism 25 that holds the magnetic heads 17 in an unloaded position remote away from the respective magnetic disks 18 when the magnetic heads 17 move to the outermost circumferences of the magnetic disks 18, a spoiler 70, and a substrate unit (FPC unit) 34 on which electronic components such as conversion connectors are mounted. The ramp load mechanism 25 includes a ramp 80 provided to stand upright on the bottom wall 12a.

The actuator assembly 27 comprises an actuator block 29 having a through hole, a bearing unit (unit bearing) 28 provided in the through hole, a plurality of, for example, twelve arms 32 extending from the actuator block 29, and suspension assemblies (head gimbal assemblies: HGAs) 30 mounted to the arms 32, respectively, and magnetic heads 17 supported by the suspension assemblies 30, respectively. The actuator block 29 is supported rotatable around the support shaft 26 provided to stand upright on the bottom wall 12a by the bearing unit 28.

The FPC unit 34 includes a substantially rectangular-shaped base portion 34a bent into an L-shape, a slender strip-shaped relay portion 34b extending from an edge on one side of the base portion 34a, and a joint portion 21c provided in continuity with a tip of the relay portion 34b, which are all formed to be integrated as one body. The base portion 34a, the relay portion 34b, and the joint portion 21c are each formed from a flexible printed circuit board (FPC).

On the base portion 34a, electronic components including the conversion connectors, multiple capacitors, and the like are mounted and electrically connected to the wiring of the FPC. The base portion 34a is mounted on the bottom wall 12a of the base 12. The relay portion 34b extends from a side edge of the base portion 34a toward the actuator block 29 of the actuator assembly 27. The joint portion 21c provided at the extending end of the relay portion 34b is adhered to and fixed by screws to the side surface (mount surface) of the actuator block 29. On the joint portion 21c, a plurality of connection pads are provided. The magnetic heads 17 of the actuator assemblies 27 are electrically connected to the connection pads of the joint portion 21c via wiring members, respectively.

Onto the outer surface of the bottom wall 12a of the base 12, a printed circuit board 41 is fastened by screws. The printed circuit board 41 constitutes a control unit, which controls the operation of the spindle motor 19 and, through the board unit 34, controls the operation of the VCM 24 and the magnetic heads 17.

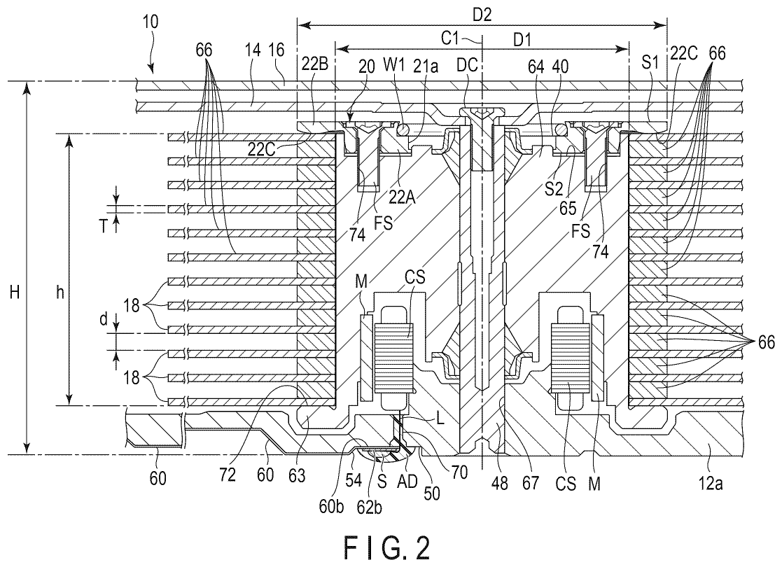

FIG. 2 is a cross-sectional view of the portion of the spindle motor of the HDD taken along the line A-A in FIG. 1. As shown in FIG. 2, in one example, the spindle motor 19 includes a pivot shaft 48 provided to stand substantially vertically relative to the bottom wall 12a, a cylindrical spindle hub 64 supported to be rotatable around the pivot shaft 48, a stator coil CS fixed to the bottom wall 12a and disposed around the pivot shaft 48, and a cylindrical magnet M mounted on the inner circumferential surface of the spindle hub 64 and facing the stator coil CS.

The proximal end portion of the pivot shaft 48 is press-fitted and engaged into a through hole 67 formed in the bottom wall 12a. The extending end (upper end) of the pivot shaft 48 is fixed to an inner cover 14 by a fixation screw DS.

The pivot shaft 48 and the spindle hub 64 have a center axis C1. The spindle hub 64 has an outer circumferential surface located to be coaxial with the pivot shaft 48 and a ring-shaped flange 63 formed to be integrated with the lower end (end on the side of the bottom wall 12a) of the outer circumferential surface. The flange 63 has a ring-shaped disk mounting surface 72 on which the magnetic disk 18 is mounted. The lower end of the spindle hub 64 and the flange 63 are positioned to face the inner surface of the bottom wall 12a with a gap of, for example, approximately 0.4 mm. Further, in the upper end surface of the spindle hub 64, a ring-shaped recess 65 formed. The recess 65 is positioned around the pivot shaft 48. The outer diameter of the recess 65 is set slightly smaller than the outer diameter of the spindle hub 64.

A flexible printed circuit board (FPC) 60 for supplying current to the spindle motor 19 is attached and fixed to the outer surface of the bottom wall 12a. On the outer surface of the bottom wall 12a, a recess 50 of a predetermined shape is formed around the pivot shaft 48. At the boundary between the recess 50 and the outer surface of the bottom wall 12, a step portion 54 is formed. The FPC 60 includes one end portion connected to the printed circuit board 41, another end portion 60b disposed within the recess 50, and multiple connection pads 62b provided on the other end portion 60b. The connection pads 62b are electrically connected to the wiring lines of the FPC 60. To the connection pads 62b, lead wires L drawn from the coil CS of the spindle motor 19 are joined using a solder S. The recess 50 is filled with an adhesive AD, which covers the connection pads 62b and the solder-joined portions.

The magnetic disks 18 are engaged with the outer circumferential surface of the spindle hub 64 while the spindle hub 64 is inserted into the inner holes thereof. Further, on the outer circumferential surface of the spindle hub 64, ring-shaped spacer rings 66 are mounted such that each one is sandwiched between each respective adjacent two magnetic disks 18. The magnetic disks 18 and spacer rings 66 are displaced in order on the flange 63 of the spindle hub 64 and mounted on the spindle hub 64 in a state where they are alternately stacked.

The disk-shaped clamp (hereinafter referred to as a clamp) 20 is attached to the upper end of the spindle hub 64. The inner circumferential portions of the multiple magnetic disks 18 and the spacer rings 66 are pressed against the flange 63 side by the clamp 20. With this configuration, the twelve magnetic disks 18 are fixed to the spindle hub 64 in a state there they are stacked with predetermined intervals therebetween and are supported so as to be rotatable integrally with the spindle hub 64. The twelve magnetic disks 18 are supported parallel to each other, and substantially parallel to the bottom wall 12a at predetermined intervals therebetween.

The housing 10 including the top cover 16 is formed to have a height (thickness) H of, for example, a maximum of 26.1 mm so as to be comply with the 3.5-inch HDD specification. The magnetic disks 18 are each formed to have a plate thickness T of 0.35 to 0.635 mm, and in this embodiment, the thickness is set to 0.43 mm. The spacing d (equivalent to the thickness of the spacer) between each adjacent pair of magnetic disks 18 is formed to be 1.2 mm or more and 1.65 mm or less, and in this embodiment, it is set to 1.304 mm. The stack height h of the all magnetic disks in total (the height from the lower surface of the lowermost magnetic disk to the upper surface of the uppermost magnetic disk) is set to 19.504 mm in this embodiment.

The clamp 20 will now be described in detail.

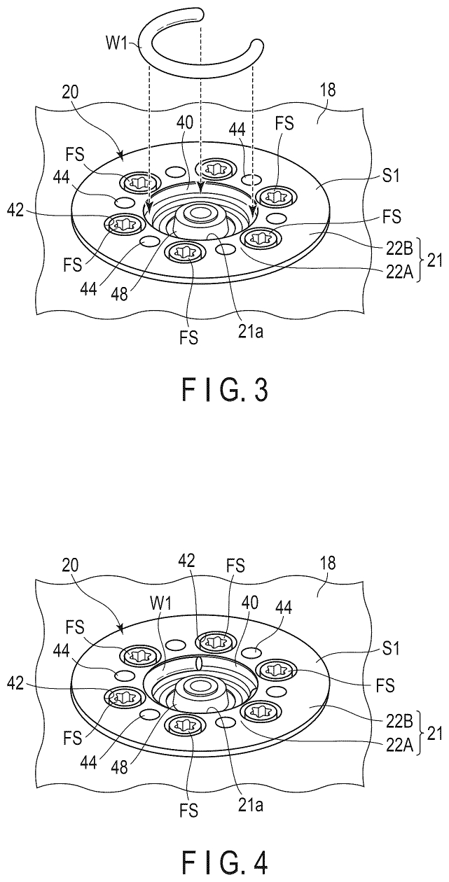

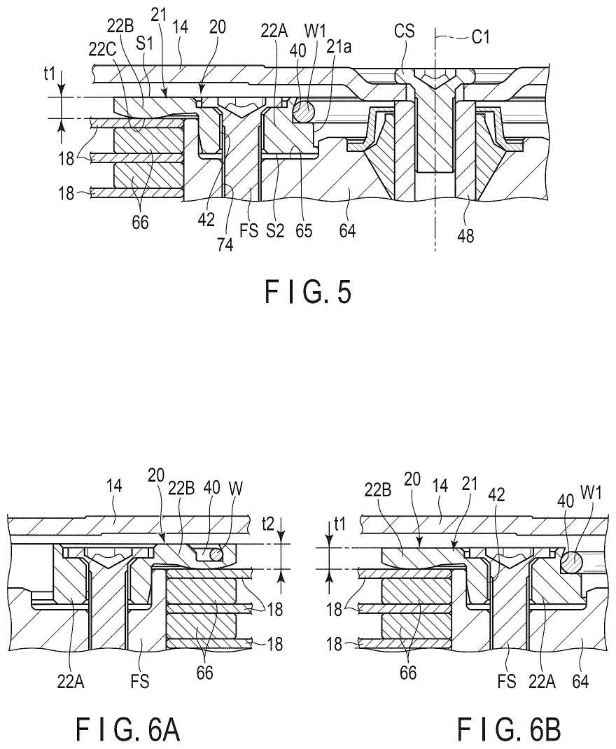

FIG. 3 is a perspective view of the disk clamp and the imbalance adjustment member (wire), FIG. 4 is a perspective view of the disk clamp with the wire installed, and FIG. 5 is a cross-sectional view of the disk clamp portion, illustrating with an enlarged portion of FIG. 2.

As shown in FIGS. 2 and 3, the clamp 20 includes a disk-shaped main body 21 having a center (center axis) C1. The main body 21 has an inner hole 21a coaxial with the center axis C1 and forms a ring shape. The main body 21 is formed, for example, from stainless steel. The main body 21 is disposed at the upper end of the spindle hub 64 while the center axis C1 coincides with the center axis C1 of the pivot shaft 48 and is fixed to the spindle hub 64 by multiple fixation screws FS.

As shown in FIGS. 2 and 3, the main body 21 has a first surface S1 that is substantially flat and located on the side of the top cover 16, and a second surface S2 that is located on the side of the magnetic disks 18. The inner circumferential portion of the main body 21 is formed to have a plate thickness greater than that of the outer circumferential portion, and thus constitutes a ring-shaped fixation portion 22A. The outer circumferential portion of the main body 21 constitutes a ring-shaped pressing portion 22B having a plate thickness less than that of the fixation portion 22A. On the second surface S2, the second surface of the pressing portion 22B is formed into an arc shape slightly protruding toward the side of the magnetic disks 18, and thus constitutes a contact surface 22C that is in contact with the magnetic disk 18.

The outer diameter D2 of the main body 21 (the outer diameter of the pressing portion 22B) is greater than the outer diameter D1 of the spindle hub 64 (the inner diameter of the magnetic disk 18) and is set to be approximately the same as the outer diameter of the spacer ring 66. The inner diameter of the pressing portion 22B, that is, the outer diameter of the fixation portion 22A, is set to be less than the outer diameter D1 of the spindle hub 64.

When the main body 21 is fixed to the spindle hub 64 while the fixation portion 22A is housed in the recess 65 of the spindle hub 64, the contact surface 22C of the pressing portion 22B is brought into contact with the upper surface on the inner circumferential side of the magnetic disk 18, and thus the magnetic disks 18 are pressed toward the side of the flange 63.

As shown in FIGS. 3, 4, and 5, the clamp 20 includes an annular mount groove 40 formed on the main body 21, on which an imbalance adjustment member, such as a wire is to be mounted, a plurality of, for example six through holes (socket holes) 42 through which fixation screws FS for fixing the clamp 20 are inserted, and a plurality of, for example, six through holes 44 for positioning and holding the clamp 20.

The mount groove 40 has a circular ring-shape that is coaxial with the center axis C and is formed on the circumferential surface of the inner hole 21a of the fixation portion 22A. In this embodiment, the mount groove 40 is opened to the circumferential surface of the inner hole 21a and the first surface S1 of the main body 21. The mount groove 40 is formed to have a diameter of approximately 14 mm, for example.

The six through holes 42 are formed to penetrate the fixation portion 22A of the main body 21 and each extend parallel to the center axis C. The six through holes 42 are each positioned at such sites that the centers of the holes coincide with a circle of radius r, and further disposed to be spaced apart from each other at equal intervals in the circumferential direction. The through holes 42 are not threaded. In this embodiment, the radius r thereof is set to 10 mm.

The six through holes 44 are formed in the fixation portion 22A at such respective sites that the centers of the holes coincide with the center of a circle having a radius r. The six through holes 44 are disposed to be spaced apart from each other at equal intervals in the circumferential direction and are each positioned in an intermediate portion between each pair of through holes 42 adjacent to each other in the circumferential direction. In one example, the through holes 44 are bottomed holes, in each of which one end is opened to the first surface S1 of the main body 21 and the other end is closed.

As shown in FIGS. 2, 4, and 5, the clamp 20 is overlaid on the upper end of the spindle hub 64 and disposed to be coaxial with the spindle hub 64. Then, it is fastened to the spindle hub 64 by six fixation screws FS. The fixation portion 22A of the clamp 20 is fitted into the recess 65 provided in the spindle hub 64. The fixation screws FS are inserted to penetrate the through holes 42, respectively, from the side of the first surface S1 and further screwed into the screw holes 74 of the spindle hub 64, respectively. With this configuration, the fixation portion 22A of the clamp 20 is fixed to the spindle hub 64, and the contact surface 22C of the pressing portion 22B is brought into contact with the inner circumferential portion of the uppermost magnetic disk 18, thus clamping the magnetic disk 18 and the spacer ring 66.

When adjusting the imbalance of the rotating members such as the magnetic disks 18 and the spacer rings 66, a wire W1 serving as an imbalance adjustment member is mounted in the mount groove 40 of the clamp 20. The wire W1 is formed, for example, from stainless steel, SUS304, or brass. In one example, a stainless steel wire W1 having a diameter of 1.12 mm can be used. The wire W1 is installed in the mount groove 40 and is fixed to the main body 21 by the restoring force of the wire itself tending to expand outward. That is, the wire W1 is held in the mount groove 40 in a state where it is pressed against the circumferential surface of the inner hole 21a. At this time, the wire W1 is held in the mount groove 40 without protruding from the first surface S1 of the main body 21.

FIG. 6A is a cross-sectional view of the clamp 20 of an HDD according to a comparative example, and FIG. 6B is a cross-sectional view of the clamp 20 of the HDD according to the present embodiment. As shown in FIG. 6A, in the clamp 20 of the comparative example, the mount groove 40 is provided in the pressing portion (outer circumferential portion) 22B of the main body 21, and a wire W, for example, having a diameter of 0.65 mm, is mounted in the mount groove 40. In the case of the comparative example, the thickness t2 of the pressing portion 22B needs to be set to, for example, 1.3 to 2 mm.

In contrast, as shown in FIG. 6B, in the clamp 20 of the HDD according to the present embodiment, the mount groove 40 is provided in the inner circumferential portion of the main body 21, that is, the inner circumferential surface of the inner hole 21a of the fixation portion 22A, and is not provided in the pressing portion 22B. With this configuration, the pressing portion 22B does not need to secure a thickness to accommodate the mount groove, and therefore the thickness of the pressing portion 22B can be reduced. In one example, the thickness t1 of the pressing portion 22B can be set to approximately 0.8 to 1.5 mm, and this it can be made sufficiently less than the thickness T2 of the pressing portion 22B in the comparative example.

By reducing the thickness t1 of the pressing portion 22B, that is, by reducing the height of the first surface S1 of the clamp 20, the disk mount space can be expanded by the amount reduced, thereby making it possible to increase the number of magnetic disks 18 that can be mounted.

The amount of imbalance correction of the wire W1 in the case where the mount groove 40 and wire W1 are provided in the inner circumferential portion of clamp 20 will be described.

Generally, the imbalance correction capability can be adjusted by the length, diameter, and material of the wire W1.

According to the clamp 20 of the present embodiment, when using a stainless steel wire W1 having a diameter of 1.12 mm, the balance correction capability of the wire W1 is approximately 55% of the balance correction capability of the clamp 20 of the comparative example when a stainless steel wire W having a diameter of 0.65 mm is mounted. Alternatively, when a wire W1 is made of brass, the balance correction capability of the wire W1 is approximately 59% of the balance correction capability of the comparative example described above. Thus, according to the clamp 20 of the present embodiment, the wire W1 can ensure sufficient balance correction capability even when twelve magnetic disks 18 are mounted.

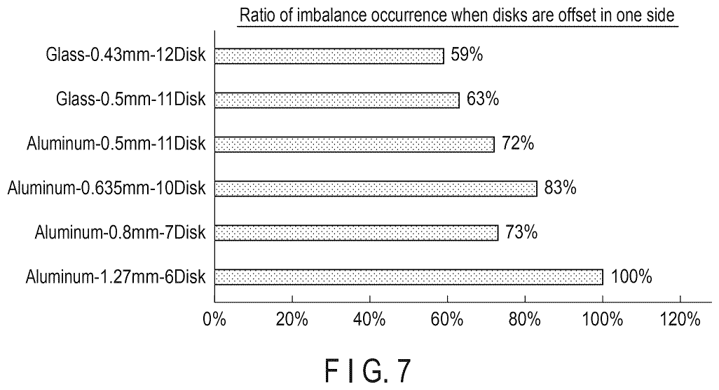

FIG. 7 is a diagram showing a comparison in the ratio of imbalance when the magnetic disks installed are unevenly located in the same direction as to multiple magnetic disk devices of different magnetic disk materials and having different numbers of disks installed.

As shown in FIG. 7, when the imbalance occurrence ratio for a drive in which six aluminum disks having a thickness of 1.27 mm are installed is set to 100%, the imbalance occurrence ratio in a drive in which seven aluminum disks having a thickness of 0.8 mm are installed is 73%, the imbalance occurrence ratio in a drive in which ten aluminum disks having a thickness of 0.635 mm are installed is 83%, the imbalance occurrence ratio in a drive in which eleven aluminum disks having a thickness of 0.5 mm are installed is 72%, the imbalance occurrence ratio in a drive in which eleven aluminum disks having a thickness of 0.5 mm are installed is 63%, and the imbalance occurrence ratio in a drive in which twelve aluminum disks having a thickness of 0.43 mm are installed is 59%.

As shown in FIG. 7, as the number of magnetic disks installed increases, the thickness of the disks tends to decrease. Therefore, even when the number of disks installed is increased, the weight of each individual disk decreases. With this configuration, the ratio in the amount of imbalance occurring when all disks are offset in one side in the radial direction relative to the center axis tends to decrease. Further, by replacing the disk material from aluminum to glass, which is lighter in weight, the ratio in imbalance ratio can be further reduced.

For example, when the ratio in imbalance occurring in a drive in which six aluminum disks having a thickness of 1.27 mm are installed is set to 100%, the ratio in imbalance occurring in a drive in which twelve glass disks having a thickness of 0.43 mm are installed is 59%, and here it can be understood that the imbalance correction capability required of the imbalance adjustment member (wire W1) is approximately 60% of that required for the six aluminum disks.

According to the first embodiment described above, the mount groove 40 is provided in the inner circumferential surface of the clamp 20, and with this configuration, the thicknesses of the clamp and the pressing portion can be reduced, thereby making it possible to expand the disk mounting space. In this manner, it is possible to realize an HDD which can install twelve or more magnetic disks. Further, even when an imbalance adjustment member, such as the wire W1, is mounted in the mount groove 40 provided in the inner circumferential surface of the clamp 20, the wire W1 can ensure sufficient imbalance correction capability in a drive in which twelve magnetic disks 18 are installed.

As described above, according to the present embodiment, it is possible to provide a disk clamp that can be made thin and a disk device comprising such a clamp.

Next, the clamp of an HDD according to another embodiment of the present invention will be described. In the other embodiment described below, the same parts as those used in the first embodiment will be denoted by the same reference numerals, and the detailed description of such parts is omitted or simplified. The parts different from those of the first embodiment will be mainly discussed.

### Second Embodiment

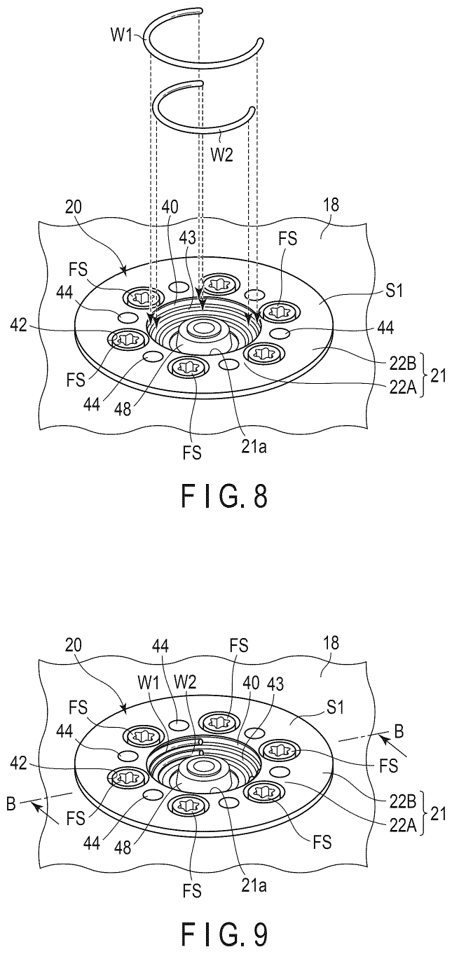

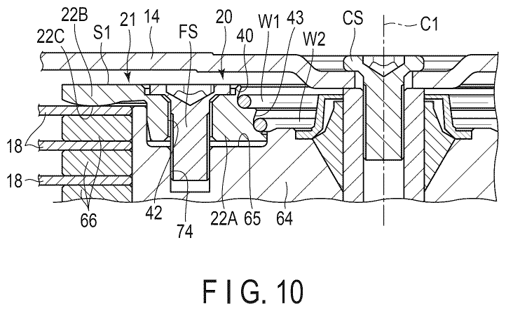

FIG. 8 is a perspective view of a disk clamp and an imbalance adjustment member (wire) of an HDD according to the second embodiment, FIG. 9 is a perspective view of the disk clamp in which the wire is installed in the second embodiment, and FIG. 10 is a cross-sectional view of the disk clamp taken along the line B-B in FIG. 9.

As shown in FIGS. 8, 9, and 10, in the second embodiment, the clamp 20 is configured such that two wires W1 and W2 can be mounted as imbalance adjustment members. In detail, two-step mount grooves 40 and 43 are provided in the inner circumferential surface of the inner hole 21a of the main body 21. The mount groove (first mount groove) 40 has an annular or a circular ring-shape that is coaxial with the center axis C1 and is opened to the first surface S1 of the main body 21 and the inner circumferential surface of the inner hole 21a. The mount groove (second mount groove) 43 has an annular or a circular ring-shape coaxial with the center axis C1 and has a diameter smaller than that of the mount groove 40. The mount groove 43 is provided offset toward the second surface S2 with relative to the mount groove 40 and is opened to the inner circumferential surface of the inner hole 21a.

In the mount groove 40, a wire (first wire) W1 is mounted as an imbalance adjustment member. In one example, the wire W1 may be made of stainless steel with a diameter of 0.65 mm. The wire W1 is installed in the mount groove 40 and is held within the mount groove 40 in a state where it is pressed against the circumferential surface of the inner hole 21a by its own restoring force. At this time, the wire W1 is held within the mount groove 40 without protruding from the first surface S1 of the main body 21.

In the mount groove 43, a wire (second wire) W2 is installed. In one example, the wire W2 may be made of stainless steel with a diameter of 0.65 mm. The wire W2 is installed in the mount groove 43 and is held within the mount groove 43 in a state where it is pressed against the circumferential surface of the inner hole 21a by its own restoring force.

In the second embodiment, the other configurations of the clamp 20 are the same as those of the clamp 20 in the first embodiment. According to the second embodiment, the clamp 20 can ensure a greater imbalance correction capability by using two wires in combination.

As described above, according to the second embodiment, it is possible to provide a disk clamp which can be thinned and a disk device comprising such a clamp.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

For example, in the first and second embodiments, the imbalance adjustment member is not limited to a wire having a circular cross section, but may as well be of a plate material with a rectangular cross section (a plate-shaped member bent into an arc shape). The number of mount grooves of the clamp 20 is not limited to one or two, but may as well be three or more. The material of the imbalance adjustment member is not limited to stainless steel or brass, but may be changed as appropriate. The numbers of fixation screws FS and through holes 42 are not limited to six, but may be increased or decreased as necessary.

What is claimed is

1. A disk clamp comprising:
a disk-shaped main body including a flat first surface, a second surface on an opposite side to the first surface, a center axis perpendicular to the first surface, and an inner hole formed to be coaxial with the center axis,
wherein
the main body includes a ring-shaped pressing portion having a first thickness along the center axis, a ring-shaped fixation portion having a second thickness greater than the first thickness and the inner hole, and provided on an inner circumferential side of the pressing portion, a mount groove formed in an inner circumferential surface of the inner hole, in which an imbalance adjustment member can be accommodated, and a plurality of through holes each formed in the fixation portion, through which fixation screws can be penetrated, respectively.

2. The disk clamp of claim 1, wherein
the mount groove is a ring-shaped groove coaxial with the center axis.

3. The disk clamp of claim 2, wherein
the mount groove is opened to the first surface and the inner circumferential surface of the inner hole.

4. The disk clamp of claim 1, wherein
the imbalance adjustment member includes either a wire or a plate material.

5. The disk clamp of claim 4, wherein
the imbalance adjustment member has an arc shape extending to a semicircle or over.

6. The disk clamp of claim 4, wherein
the imbalance adjustment member is formed of either stainless steel or brass.

7. The disk clamp of claim 1, wherein
the mount groove includes a ring-shaped first mount groove formed in the inner circumferential surface of the inner hole, and a ring-shaped second mount groove formed in the inner circumferential surface of the inner hole and located by the first mount groove in a direction of the center axis.

8. The disk clamp of claim 7, wherein
the imbalance adjustment member includes a first wire that can be mounted in the first mount groove and a second wire that can be mounted in the second mount groove.

9. A disk device comprising:
a housing;
a spindle motor including a spindle hub rotatably mounted therein and disposed in the housing;
twelve or more magnetic disks mounted on the spindle hub, and
a disk clamp of claim 1, fixed to the spindle hub and clamping the magnetic disks.

10. The disk device of claim 9, wherein
the twelve or more magnetic disks, each having a thickness of 0.43 mm and a diameter of 3.5 inches, are stacked on a flange of the spindle hub and clamped between the flange and the pressing portion of the disk clamp.

11. The disk device of claim 9, wherein
the housing is filled with a low-density gas having a density lower than that of air.

12. The disk device of claim 9, wherein
the mount groove is a ring-shaped groove coaxial with the center axis.

13. The disk device of claim 12, wherein
the mount groove is opened to the first surface and the inner circumferential surface of the inner hole.

14. The disk device of claim 9, wherein
the imbalance adjustment member includes either a wire or a plate material.

15. The disk device of claim 14, wherein
the imbalance adjustment member has an arc shape extending to a semicircle or over.

16. The disk device of claim 14, wherein
the imbalance adjustment member is formed of either stainless steel or brass.

17. The disk device of claim 9, wherein
the mount groove includes a ring-shaped first mount groove formed in the inner circumferential surface of the inner hole, and a ring-shaped second mount groove formed in the inner circumferential surface of the inner hole and located by the first mount groove in a direction of the center axis.

18. The disk device of claim 17, wherein
the imbalance adjustment member includes a first wire that can be mounted in the first mount groove and a second wire that can be mounted in the second mount groove.
